(19) United States
(12) Patent Application Publication
(10) Pub. No.: US 2002/0059562 A1
(43) Pub. Date: May 16, 2002

(54) Apparatus for collecting profiles of programs

(76) Inventor: Yutaka Haga, Bellevue, WA (US)

Correspondence Address: STAAS & HALSEY LLP, 700 11TH STREET, NW, SUITE 500, WASHINGTON, DC, 20001, US

(21) Appl. No.: 09/778,076

(22) Filed: Feb. 7, 2001

(30) Foreign Application Priority Data
Sep. 26, 2000 (JP) 2000-292736

(51) Int. Cl. G06F 9/44

(52) U.S. Cl. 717/130

(57) ABSTRACT

According to an apparatus for collecting a profile of a program, a CPU generates an interrupt when a branch instruction is executed during the execution of the program. In this interrupt, an analyzing section determines whether the executed branch instruction is a instruction relating to the execution of a subroutine, and, in the case where the branch instruction is a instruction relating to the execution of the subroutine, a collecting section extracts a profile of the subroutine and stores it in a profile memory section.

### BACKGROUND OF THE INVENTION

1. Field of the Invention

The present invention relates to an apparatus for collecting performance information (profiles) of programs which are executed in a computer system.

2. Description of the Related Art

Conventional methods for analyzing in detail the performance (profiling) of subroutines (also termed “procedures”, “functions”, etc.) include the following methods.

(1) Burying control codes for profiling the subroutines in the program beforehand.

(2) Analyzing the program, and altering the program so as to intercept the calling instruction of the subroutine.

However, these conventional methods have the following problems. The method of (1), in which control codes for profiling the subroutine are buried beforehand in the program, results in increased overheads when executing the program. For this reason, when using the method of (1), the control codes, which are buried in the program during development, have often been omitted from the program of the consignment of the finished product. Consequently, it has been difficult to apply the method of (1) to the program of the finished product.

In the method of (2), the program is analyzed and altered so as to intercept the calling instruction of the subroutine. When the alteration is detected in a an accuracy test of the program itself, there is a possibility that the detected alteration will be determined to be incorrect and the program will stop operating.

### SUMMARY OF THE INVENTION

It is an object of this invention to provide an apparatus for collecting a profile of a program, the apparatus being capable of collecting subroutine profiles without altering the program.

In order to achieve the above objects, this invention comprises an apparatus for collecting a profile of a subroutine in a program, the apparatus collecting the profile of said subroutine by using an interrupt generated when a branch instruction is executed during execution of said program.

According to this invention, the profile is collected by using an interrupt. Therefore, it is not necessary to bury control codes in the program, or alter the program. This makes it possible, for example, to collecting and analyze profiles of subroutine in a program of a final product. A profile comprises, for example, the cumulative execution time of the subroutine, times of calling, the overhead, etc.

According to this invention, profiles may be collected for each executor of a subroutine. In this way, detailed profiles of the subroutines can be collected, and the program can be analyzed in detail. An executor comprises a process (also termed a “task”) or a thread.

### BRIEF DESCRIPTION OF THE DRAWINGS

FIG. 1 is a diagram showing the hardware constitution of a computer which functions as an apparatus for collecting profiles of programs;

FIGS. 2A and 2B are function block diagrams of an apparatus for collecting the profiles of programs;

FIGS. 3A and 3B are diagrams showing examples of the constitution of control tables;

FIG. 4 is a flowchart showing processes of an analyzing section;

FIG. 5 is a flowchart showing processes of a profile collection section;

FIG. 6 is a flowchart showing processes of a profile collection section;

FIG. 7 is a flowchart showing processes of a profile collection section; and

FIGS. 8A and 8B are diagrams showing one example of the constitution of a control table in a second embodiment.

### DETAILED DESCRIPTION OF THE PREFERRED EMBODIMENTS

Preferred embodiments of the present invention will be explained with reference to the accompanying drawings. The embodiments which follow are examples, and this invention is not limited to these embodiments.

[First Embodiment]

<Hardware Constitution>

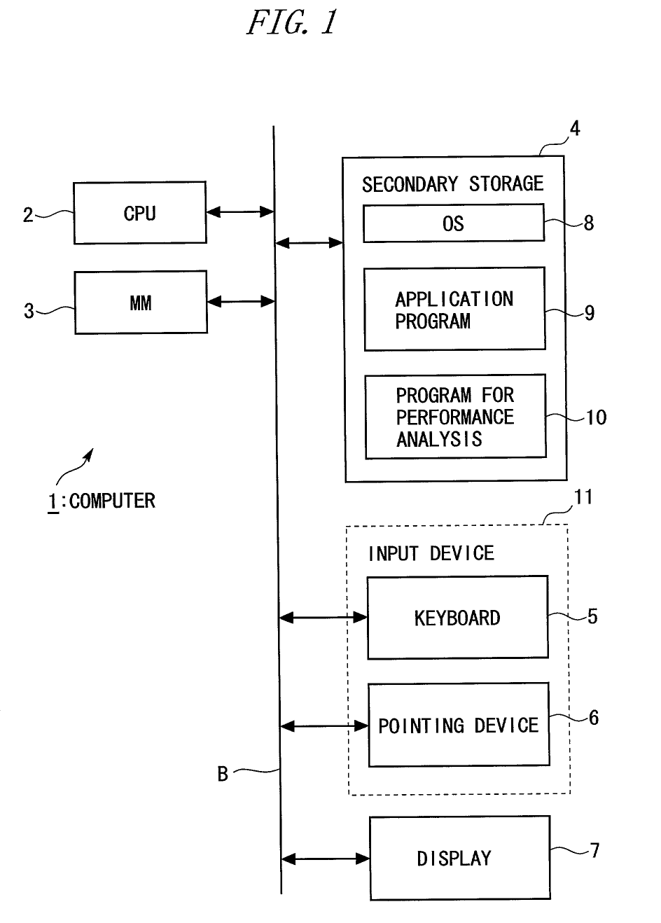

FIG. 1 is a block diagram showing the hardware of a computer 1 according to an embodiment of this invention. The computer 1 functions as the apparatus for collecting profile of a program of this invention. The computer 1 for example comprises a personal computer (PC) or a workstation (WS). The computer 1 comprises a CPU 2, a main memory (MM) 3, a secondary storage 4, a keyboard 5, a pointing device 6, and a display 7, which are connected together via a bus B.

The secondary storage 4 corresponds to a computer-readable recording medium of this invention. The secondary storage 4 is constructed by using any type of recording medium such as a semiconductor memory (e.g. ROM, RAM, SRAM, a flash memory, EPROM, EEPROM), a magnetic disk (e.g. a hard disk, a floppy disk), an optical disk (e.g. a CD-ROM, a PD), or an optical magnetic disk (MO).

An operating system (OS) 8, at least one application program 9 (hereinafter termed “application 9”), and a program for analyzing performance (hereinafter termed “analyzing program 10”) are installed in the secondary storage 4. The secondary storage 4 also holds data which is used in executing the programs 8, 9, and 10.

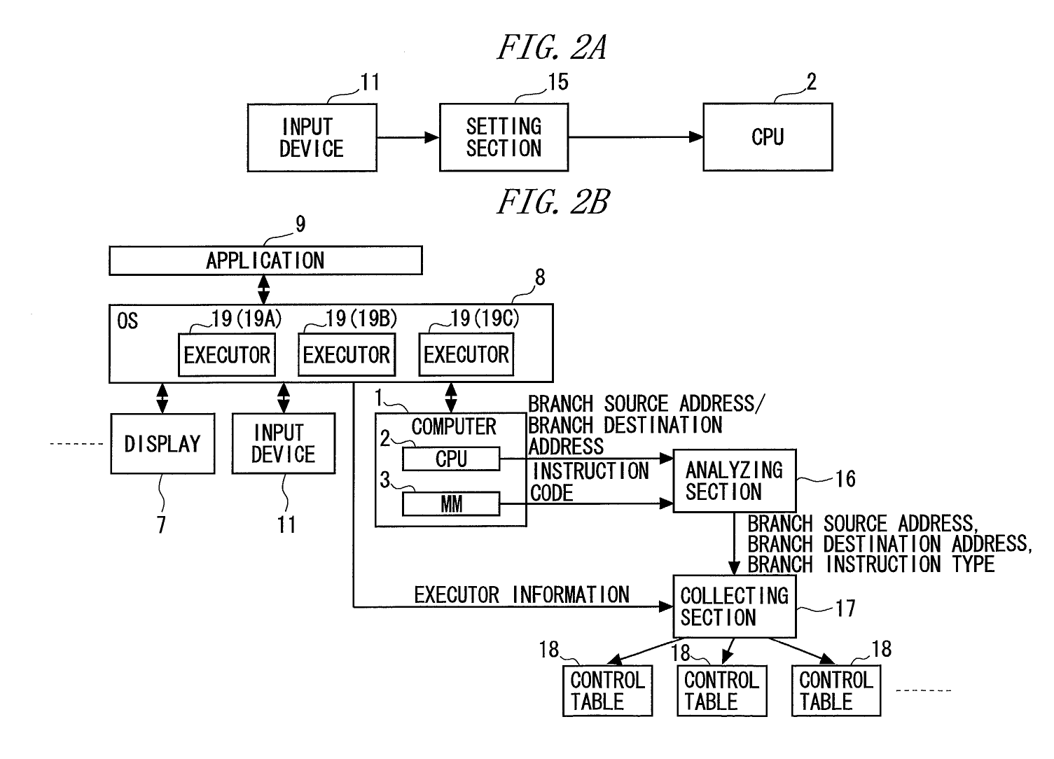

The OS 8 is provided between the hardware of the computer 1 (the CPU 2, the MM 3, etc.) and the application 9, and absorbs differences in the hardware. In addition, the OS 8 controls and manages execution of the hardware. The OS 8 creates at least one executor 19 for executing the application 9 (see FIG. 2). By way of example, FIG. 2 shows three executors 19 (19A, 19B, and 19C).

The application 9 is an application program which is executed on the OS 8, and corresponds to a program of a target of analyzing of this invention. The application 9 comprises a combination of a main routine and single or plural of subroutine(s), or alternatively comprises a combination of a plurality of subroutines. In this example, the application 9 comprises a combination of a main routine and a plurality of subroutines.

The analyzing program 10 is a program for collecting performance information (profiles) relating to the subroutines of the application 9. That is, the analyzing program 10 makes the computer 1 to function as the apparatus for collecting profiles of this invention.

The analyzing program 10 may be installed from a portable recording medium, such as a CD-ROM and a floppy disk, to the secondary storage 4 (e.g. a hard disk). Alternatively, the computer 1 may download the analyzing program 10 from another computer via a communication line, and install it into the secondary storage 4.

The keyboard 5 and the pointing device 6 are used to input commands and data to the computer 1. Hereinafter, “input device 11” will be used when referring jointly to the keyboard 5 and the pointing device 6. The pointing device 6 is, for example, any one of a mouse, a joystick, a trackball, and a flat point (flat space).

The display 7 comprises a cathode ray tube (CRT), a liquid crystal display (LCD), a plasma display, and the like, and displays information to enable the user to input data and commands, results of executed programs, and the like.

The MM 3 is used as an operation region of the CPU 2, and also functions as a video memory (VRAM) which holds data for displaying information on the display 7.

The CPU 2 loads the OS 8, the application 9, and the analyzing program 10, which are stored in the secondary storage 4, into the MM 3 and executes the programs 8, 9 and 10. The computer 1 functions as the apparatus of this invention by executing the analyzing program 10 while the CPU 2 is executing the application 9 in the OS 8.

<Functional Constitution>

FIGS. 2A and 2B are block diagrams showing the functions of the apparatus for collecting profiles of programs which are executed by the computer 1 shown in FIG. 1. As shown in FIGS. 2A and 2B, when the CPU 2 executes the analyzing program 10, a setting section 15 of an execution environment, an analyzing section 16 of instructions, and a collecting section 17 of profiles are realized, and at least one control table 18 is created. The functions of the sections 15, 16, and 17 will be explained below.

<Setting Section>

As shown in FIG. 2A, when the CPU 2 executes the analyzing program 10, the setting section 15 becomes active. The setting section 15 provides the CPU 2 with environment settings in order to collect a profile of the application 9 according to the operation of the input device 11 by user.

Recently, the CPUs of every variety which can provide with the computer 1 have functions for generating an interrupt during execution of programs. A CPU having X86 architecture, which is widely used in PCs and the like, can generate a single-step interrupt when one instruction is executed. Some CPUs have a function for generating an interrupt only when a branch instruction has been executed.

Intel Corp.'s “Pentium Pro” is one example of a CPU having the above functions. “Pentium Pro” was followed by “Pentium II” and “Pentium III”, which have similar functions.

The “Pentium Pro” has a register comprising various types of system flags which is termed an “EFLAGS Register”. The eighth bit (bit 8) of this EFLAGS register is termed a “TF flag”. When the TF flag is set, a single-step mode for debugging becomes enabled. Conversely, when the TF flag is cleared, the single-step mode for debugging is disabled.

In the single-step mode, the processor (CPU) creates an exception of a debug after each instruction. This makes it possible to check the execution status of the program after each instruction. When the application program sets the TF flag by using a POPF, a POPFD, and an IRET instruction, a debug exception is created after the instruction which follows the POPF, the POPFD, and the IRET instruction.

The “Pentium Pro” has a DebugCtlMSR register for setting a debug function which is more detailed than that using the TR flag. The DebugCtlMSR register enables recording of the latest branch, interrupt, and exception. The DebugCtlMSR register also enables breakpoints, breakpoint announcement pins, and trace messages for executed branches.

It is possible to writes in the DebugCtlMSR register when operating at privilege level 0 and actual address mode by using a WRMSR instruction. An operating system procedure for protect mode is required in order to allow the user to access the DebugCtlMSR register.

The DebugCtlMSR register comprises an LBR (latest branch/interrupt/exception) flag (bit 0) and a BTF (branch single-step execution) flag (bit 1). This invention uses these flags. When the LBR flag is set, the processor (CPU) records the source address and destination address of the last branch, exception, and interrupt process before the debug exception is generated.

On the other hand, when the BTF flag is set, the processor (CPU) treats the TF flag of the EFLAGS register as an “branch single-step execution” flag, instead of as a “instruction single-step execution” flag. By using the LBR flag and the BTF flag in the appropriate way, the branch processing allows the CPU is able to execute single-step branch processing. To enable a debug breakpoint of the branch, the execution environment setting section 15 must set both the BTF and TF flags.

The setting section 15 combines and sets the LBR flag, the BTF flag, and the TF flag. Thereby, the CPU 1 generates an interrupt only when a branch instruction is being executed and can acquire a branch source address and branch destination address when the branch instruction is executed.

When the executor 19 for executing the program to be analyzed (application 9) on the OS 8 is created, the setting section 15 sets the execution context of the executor 19 and activates an interrupt generating function which is used when the CPU 2 executes the branch instruction.

Incidentally, the setting section 15 may be configured so as to set the environment automatically. When the CPU 2 is able to perform the settings by using a method other than the setting section 15, there is no need to provide the execution environment setting section 15 by using the analyzing program 10.

<Analyzing Section>

As shown in FIG. 2B, when the analyzing program 10 is executed while executing the application 9, the analyzing section 16 and the collecting section 17 are realized. The analyzing section 16 is an interrupt handler of the CPU 2 which receives a control from the CPU 2 when the interrupt is occurred.

The analyzing section 16, when receives the control from the CPU 2 by occurring the interrupt, receives the branch source address and the branch destination address of the branch instruction in the executed application 9 from the CPU 2.

The analyzing section 16, when obtains the branch source address and the branch destination address, reads an instruction code of the branch source address from the MM 3 and identifies types of the branch instruction by decoding the read instruction code. The types of branch instructions comprise a calling instruction of a subroutine, a return instruction of a subroutine, and a jump instruction of a subroutine.

When the branch instruction is a calling instruction or a return instruction, the analyzing section 16 gives the branch source address, the branch destination address, and the branch instruction type (calling instruction or return instruction) to the collecting section 17.

A certain CPU, when the interrupt occurs, clears the setting of the control register in order to prevent that the interrupt occurs from the execution context again. In this case, the execution context when returning the target program must be reset so that the interrupt rises continuously during execution of the branch instruction.

<Collecting Section>

In addition to the branch source address, the branch destination address, and the branch instruction type from the analyzing section 16, the collecting section 17 extracts executor identification information (executor ID) in the OS 8. When an interrupt is generated, the collecting section 17 obtains the executor ID (process ID, thread ID, and task ID) by accessing a system interface which is supplied by the OS 8. Alternatively, when an interrupt is generated, the collecting section 17 may obtain the executor ID by directly accessing the control information of the OS 8.

Then, the collecting section 17 uses the obtained executor ID to identify the executor 19 of the subroutine. Consequently, a profile of each executor 19 can be collected.

In this example, the collecting section 17 collects profiles of all the executors 19 which are created when executing the application 9. As an alternative to this, the collecting section 17 may collect a profile of at least one specific executor 19.

When the executor 19 is specified, the collecting section 17 creates/updates the control tables 18 as a storage unit for storing a profile of the subroutine which is executed by the specified executor 19.

<Control Tables>

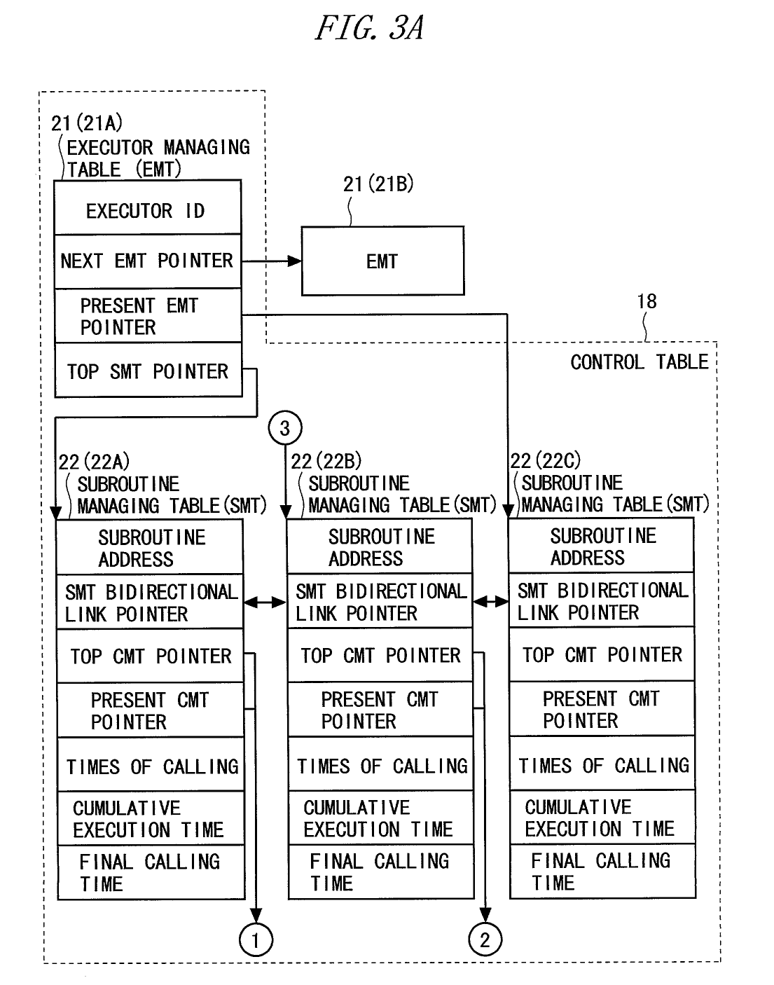

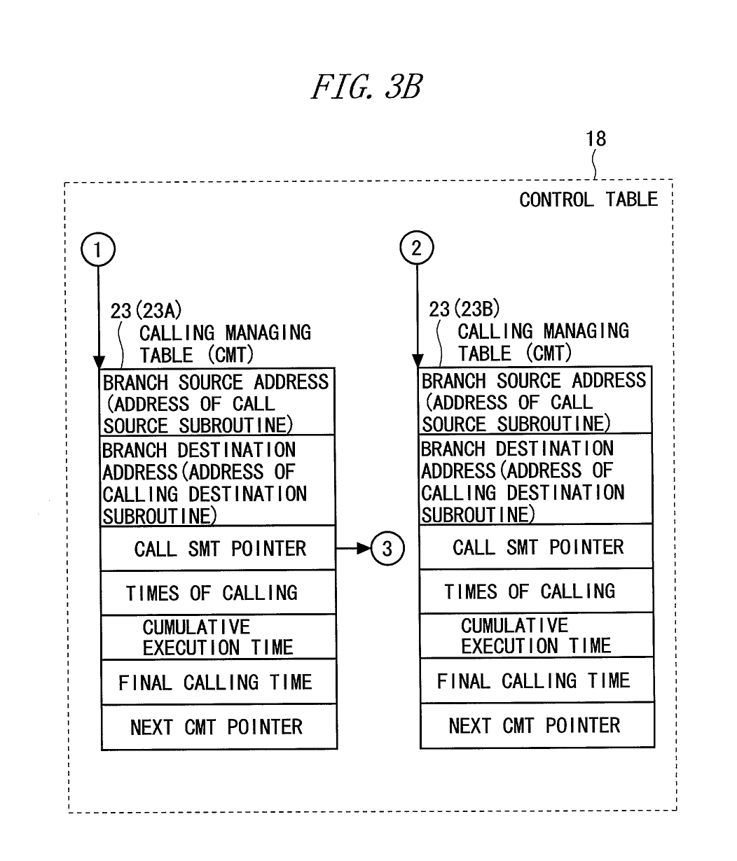

FIGS. 3A and 3B show examples of the constitution of the control tables 18 which are created/updated by the collecting section 17. The control tables 18 are created in the MM 3 and the secondary storage 4. In FIGS. 3A and 3B, the control tables 18 comprise one executor managing table (EMT) 21, at least one subroutine managing table (SMT) 22, and at least one calling managing table (CMT) 23 which is created as required.

The EMT 21 is a table for managing the SMT 22 and the CMT 23 for the subroutines which are executed by the specified executor 19. The EMT 21 stores “executor ID”, “next EMT pointer”, “present SMT pointer”, and “top SMT pointer”.

The “executor ID” comprises information for identifying the executor 19. The “next EMT pointer” represents the address of an EMT 21 in another control table 18 adjacent to the EMT 21. The “present SMT pointer” represents the address of an SMT (the SMT 22 for the presently called subroutine) 22 which corresponds to the present access target of the collecting section 17. The “top SMT pointer” represents the address of an SMT 22 which is located at the top of a plurality of SMTs 22.

The SMT 22 is a table for managing profiles of the subroutines, and is created for each subroutine which is executed by the executor 19. The number of created SMTs 22 corresponds exactly to the number of subroutines executed by the executor 19 which is managed by that EMT 21.

When there are the plurality of SMTs 22, the SMTs 22 are connected by mutual links, the collecting section 17 is possible to move between the SMTs 22. The collecting section is also possible to proceed from one SMT 22 via another SMT 22 to the destination SMT 22. Bidirectional links between the SMTs 22 are connected together when the calling of a subroutine occur, and are cancelled at return.

Each SMT 22 stores “subroutine address”, “SMT bidirectional link pointer”, “top CMT pointer”, “present CMT pointer”, “times of calling”, “cumulative value of execution time (cumulative execution time)”, and “final calling time”. The “times of calling”, “cumulative execution time”, and “final calling time” correspond to profiles of the subroutine.

The “subroutine address” represents an address of the subroutine which is executed by the executor 19 specified by the executor ID of the EMT 21. The “SMT bidirectional link pointer” is a pointer which is set when a plurality of SMTs 22 are connected by mutual links, and represents the address of at least one other SMT 22 which is mutually linked to this SMT 22.

The “top CMT pointer” represents the address of the CMT 23 at the top of at least one CMT 23 in the lower portion of the SMT 22. The “present CMT pointer” represents the address of the CMT 23 corresponding to the present access target of the collecting section 17.

The “times of calling” represents the times of which is called out the subroutine by the executor 19 specified by the executor ID of the EMT 21. The “cumulative execution time” is the total execution time of the subroutines executed by the executor 19. The “final calling time” is the final time at which the subroutine executed by the executor 19 was called out.

When one subroutine has called (nested) out another subroutine, the CMT 23 creates a table which shows the relationship (calling relationship) between the calling source subroutine (calling subroutine) and the calling destination subroutine (called subroutine or target subroutine of calling). This table is used in managing the profile of the calling destination subroutine.

The CMT 23 creates at least the minimum number of other subroutines called out by the subroutine managed by one SMT 22. When a certain subroutine is presently calling out another subroutine, the corresponding CMT 23 is shown by the “present CMT pointer” in the SMT 22 for the calling destination subroutine.

Each CMT 23 stores the “branch source address”, the “branch destination address”, the “calling destination SMT pointer”, the “times of calling”, the “cumulative value of execution time (cumulative execution time)”, the “final calling time”, and the “next CMT pointer”. The “times of calling”, the “cumulative execution time”, and the “final calling time” correspond to the profile of the subroutine in the present invention.

The “branch source address” represents the address of the subroutine corresponding to a source of the calling. The “branch destination address” represents the address of the subroutine corresponding to a destination of the calling. The “calling destination SMT pointer” represents the address of the SMT 22 corresponding to the calling destination subroutine. The above are used to store and manage the calling relationships between the subroutines.

The “times of calling” represents the times of calling from the calling source subroutine (calling subroutine) to the calling destination subroutine (called subroutine). The “cumulative execution time” represents the total execution time of the calling destination subroutine. The “final calling time” represents the final time at which the calling source subroutine called the calling destination subroutine. The “next CMT pointer” represents the address of another CMT 23 provided next (adjacent) to the CMT 23.

In the example shown in FIGS. 3A and 3B, an EMT 21 (EMT 21A) is created for one of the executors 19 (e.g. the executor 19A shown in FIG. 2). The SMTs 22A, 22B, and 22C are created as SMTs 22 for managing the profiles of the subroutines executed by the executor 19A, which is managed by the EMT 21A.

A CMT 23A is created in order to manage the profile of another subroutine, which is called out by the subroutine managed by the SMT 22A. A CMT 23B is created in order to manage the profile of another subroutine, which is called out by the subroutine managed by the SMT 22B.

The EMT 21A is connected to the EMT 21B which manages the other executors 19 which can be accessed by using the “next EMT pointer”. The collecting section 17 can access the next EMT 21B via the EMT 21A.

The SMT 22A corresponds to the top SMT of the EMT 21A. The SMT 22A is connected by a mutual link to SMT 22B, which corresponds to the next SMT after the SMT 22A. The SMT 22B is connected by a mutual link to SMT 22C, which corresponds to the next SMT after the SMT 22B.

The collecting section 17, when accesses a predetermined SMT 22, accesses the SMT 22A by using the “top SMT pointer” of the EMT 21A, and extracts the address of the predetermined SMT by using the “SMT bidirectional link pointers” of the SMTs 22A, 22B, and 22C. The collecting section 17 sets the extracted address to the “present SMT pointer” of the EMT 21A.

Consequently, the collecting section 17 can directly access the predetermined SMT 22 from the EMT 21A. In FIGS. 3A and 3B, the address of the SMT 22C is stored as the “present SMT pointer” in the EMT 21A.

When accessing a predetermined CMT 23 from an SMT 22, the collecting section 17 accesses the top CMT by using the “top CMT pointer” of the SMT 22A.

Unless the top CMT is the predetermined CMT 23, the collecting section 17 accesses the next CMT 23 by using the “next CMT pointer” in the top CMT. By repeating this process, the collecting section 17 can access the predetermined CMT 23 and set the “present CMT pointer” of the SMT 22 to the address of the predetermined CMT 23.

In FIGS. 3A and 3B, the address of the CMT 23A (CMT 23B) is stored as the “top CMT pointer” and “present CMT pointer” of the SMT 22A (SMT 22B).

Since the control tables 18 have the constitution described above, they can hold profiles of the subroutines executed by the executors 19 for each of the executors 19. The SMTs 22 hold profiles of each subroutine executed by each executor for each subroutine. The CMTs 23 store profiles of subroutines which are executed after calls from other subroutines, and the calling relationship between the subroutines.

The example of FIGS. 3A and 3B show a case where there is one subroutine nesting. When there are two or more nesting, another lower CMT 23 is created. For example, when a calling destination subroutine managed by the CMT 23A calls another subroutine, a lower CMT 23 is created in order to hold this calling relationship and the profile of the other subroutine which has been called.

Moreover, the control table 18 shown in the example of FIGS. 3A and 3B comprise data in a case where no consideration is given to “recursion” (i.e. recursion to the subroutine itself is merely regarded as a branch, and only a main routine corresponding to the calling source or a return to the subroutine is counted). Alternatively, the control table 18 can be expanded to include data which considers “recursion.” The control table 18 in this invention can have any given data constitution, such as including secondary hush retrieval data which allows efficient retrieval, and mutual links between control tables.

The control tables 18 may be created for each task and process which executes a subroutine, or for each thread in which a subroutine is executed.

<Operation Example>

Subsequently, an example of the operation of the apparatus for collecting profiles of the programs described above will be explained. In FIGS. 2A and 2B, the execution environment setting section 15 firstly supplies the above settings to the CPU 2 (see FIG. 2A). Then, the CPU 2 executes the application 9 on the OS 8. Consequently, as shown in FIG. 2B, when the application 9 is executed on the OS 8 and a subroutine in the application 9 is to be executed, an executor 19 for the subroutine is created and this executor 19 executes the subroutine.

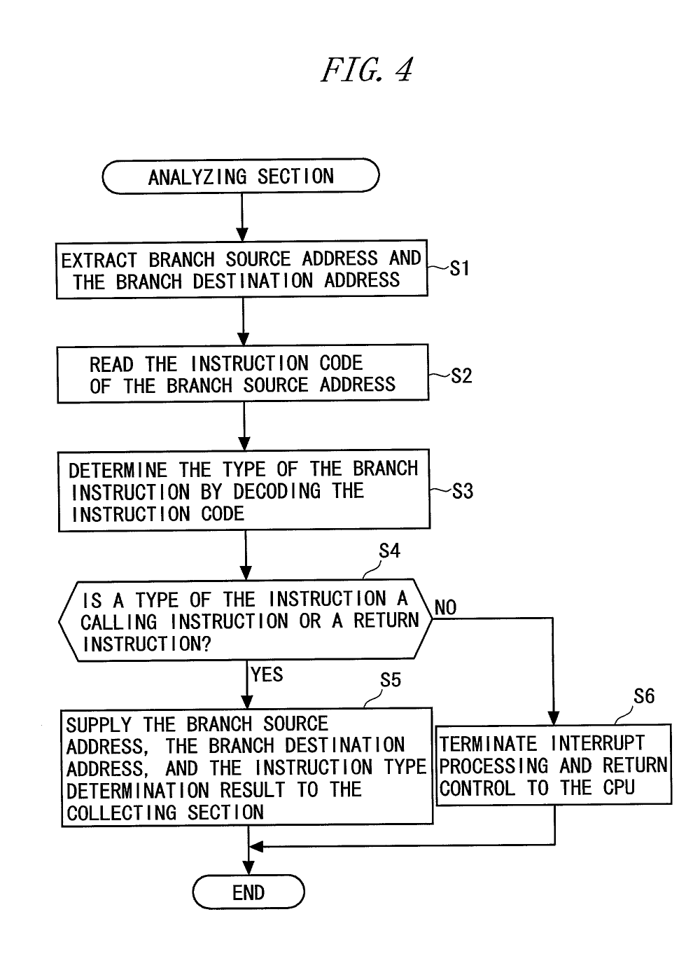

When a branch instruction is executed while executing the application 9, the CPU 2 generates an interrupt and passes control to the analyzing section 16. Consequently, the analyzing section 16 starts interrupt processing. FIG. 4 is a flowchart showing the processing performed by the analyzing section 16.

In FIG. 4, the analyzing section 16 receives the branch source address and the branch destination address of the executed branch instruction from the CPU 2 (step S1). The analyzing section 16 reads the instruction code of the branch source address from the MM 3 (step S2), and determines the type of the branch instruction by decoding the instruction format of the instruction code (step S3).

After identifying the branch instruction, the analyzing section 16 determines whether a type of the instruction is a calling instruction or a return instruction to a subroutine (step S4). That is, the analyzing section 16 identifies whether or not the branch instruction is a instruction relating to the execution of a subroutine (a calling instruction or a return instruction).

When the branch instruction is a calling instruction or a return instruction, the analyzing section 16 supplies the branch source address, the branch destination address, and a identified result of a type of the instruction to the collecting section 17 (step S5). In contrast, when the branch instruction is neither a calling instruction nor a return instruction, the analyzing section 16 terminates the interrupt processing and returns control to the CPU 2 (step S6).

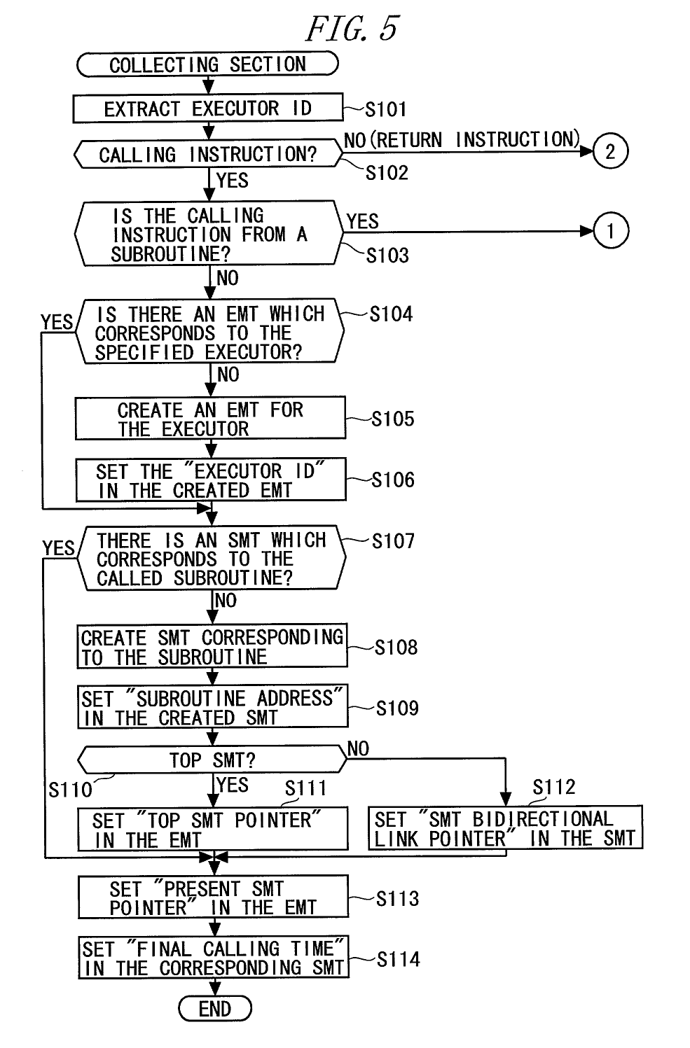

When processing has proceeded to step S5, the analyzing section 16 passes to the collecting section 17, which executes an interrupt process. FIGS. 5, 6, and 7 are flowcharts showing processes executed by the collecting section 17.

In FIG. 5, when the collecting section 17 receives the branch source address, the branch destination address, and an identified result of a type of the instruction from the analyzing section 16, the collecting section 17 extracts the executor ID of the subroutine from the OS 8 and identifies the executor 19 of the subroutine (step S101).

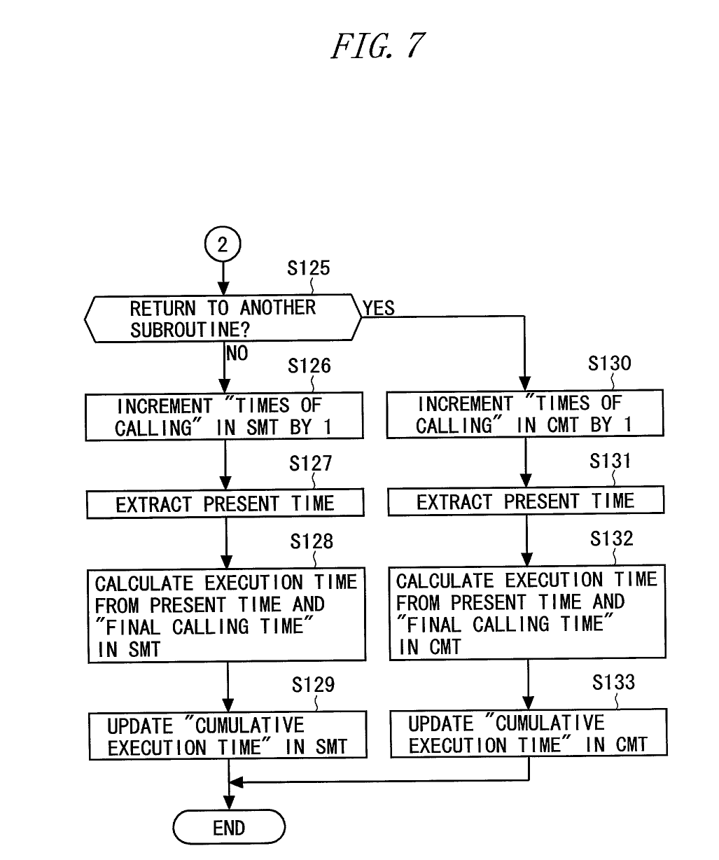

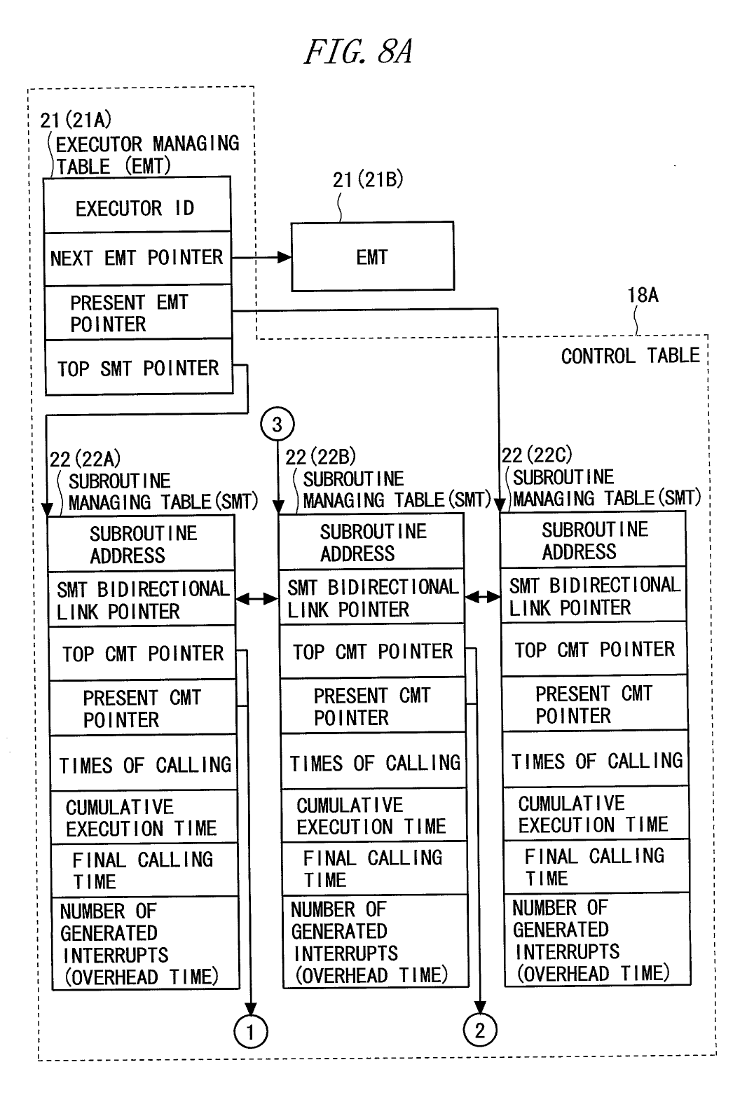

The collecting section 17 determines whether the determination result of the command type is a calling instruction of a subroutine (step S102). When the determination result is a calling instruction, processing proceeds to step S103. When the determination result is not a calling instruction (i.e. when it is a return instruction), processing proceeds to step S125 of FIG. 7.

In step S103, the collecting section 17 determines whether the calling instruction is a calling instruction from a subroutine (i.e. a calling instruction from one subroutine to another subroutine). More specifically, the collecting section 17 determines whether the branch source address received from the analyzing section 16 represents the address of a subroutine.

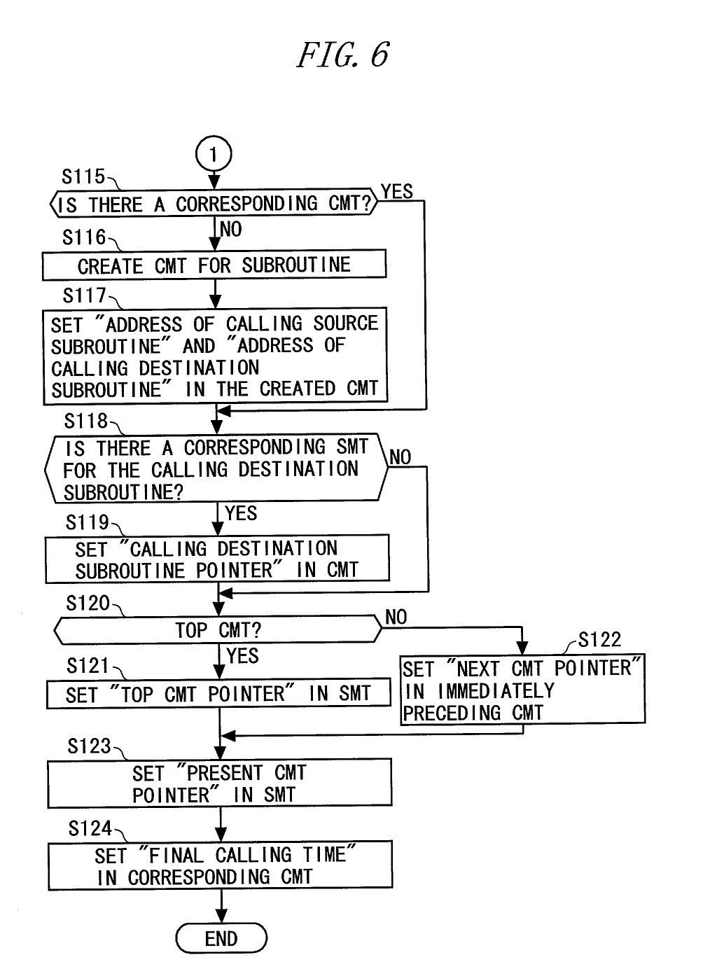

In the case where the branch source address is not the address of a subroutine (i.e. when it is the address of the main routine), the collecting section 17 deems that the calling instruction is not a calling instruction from a subroutine, and processing proceeds to step S104. On the other hand, when the branch source address is the address of a subroutine, the collecting section 17 determines that the calling instruction is a calling instruction from a subroutine, and processing proceeds to step S155 shown in FIG. 6.

When processing has reached step S104, the collecting section 17 retrieves the control table 18 comprising the EMT 21 which stores the executor ID extracted in step S101. That is, the collecting section 17 determines whether there is an EMT 21 which corresponds to the executor 19 identified in step S101. When no corresponding EMT 21 exists, the collecting section 17 proceeds to the process of step S105. When there is a corresponding EMT 21, the collecting section 17 proceeds to the process of step S107.

In step S105, the collecting section 17 determines that there is no control table 18 corresponding to the executor 19, and creates a new EMT 21 for the executor 19. As a consequence, a new control table 18 for the executor 19 is created. The collecting section 17 sets (records) the executor ID which was extracted in step S101 in the newly created EMT 21 (step S106). Thereafter, processing proceeds to step S107.

In step S107, the collecting section 17 determines whether there is a CPU 2 corresponding to the subroutine which has been called by the calling instruction. The collecting section 17 retrieves an SMT 22 which stores the branch destination address received from the analyzing section 16 as a “subroutine address”. When the SMT 22 exists, processing proceeds to step S113. When the SMT 22 does not exist, processing proceeds to step S108.

In step S108, the collecting section 17 creates a new SMT 22 for the subroutine. Then, the collecting section 17 sets (records) the branch destination address in the newly created SMT 22 as a “subroutine address” (step S109).

Subsequently, the collecting section 17 determines whether the newly created SMT 22 corresponds to the top SMT (step S110). When the SMT 22 corresponds to the top SMT, processing proceeds to step S111. Otherwise, processing proceeds to step S112.

When processing has reached step S111, the collecting section 17 sets the address of the newly created SMT 22 in the EMT 21 as the “top SMT pointer”. Thereafter, processing proceeds to step S113.

When processing has reached step S112, the collecting section 17 sets a link between one of the existing SMTs 22 and the newly created SMT 22, and sets (records) the appropriate address in the “SMT bidirectional link pointer” of the SMTs 22. Thereafter, processing proceeds to step S113.

In step S113, the collecting section 17 sets (records) the address of the SMT 22, which the address of the called subroutine has been recorded in, as the “present SMT pointer” in the corresponding EMT 21.

Then, the collecting section 17 stores the present time as the “final calling time” in the SMT 22 (step S114). The time can be obtained from a built-in clock (not shown in the diagram) of the computer 1. The collecting section 17 terminates the interrupt processing and returns control to the 2. Then, the executor 19 executes the subroutine.

When processing has reached step S115, the collecting section 17 determines whether there is a CMT 23 which corresponds to the calling destination subroutine. That is, the collecting section 17 retrieves a CMT 23 wherein the branch destination address, received from the analyzing section 16, is stored as “branch destination address”.

When the collecting section 17 has found a corresponding CMT 23, processing proceeds to step S118. When the collecting section 17 is unable to find a corresponding CMT 23, processing proceeds to step S116 for the reason that there is no CMT 23 corresponding to the calling destination subroutine.

In step S116, the collecting section 17 creates a new CMT 23 for the calling destination subroutine. Then, the collecting section 17 sets (records) the branch source address, which was obtained from the analyzing section 16, as the “calling source subroutine address” in the newly created CMT 23. In addition, the collecting section 17 sets (records) the branch destination address, which was obtained from the analyzing section 16, as the “calling destination subroutine address” in the newly created CMT 23 (step S117). Consequently, the calling relationship between subroutines when a subroutine has been nested is stored in the CMT 23. Thereafter, processing proceeds to step S118.

In step S118, the collecting section 17 determines whether the created CMT 23 corresponds to the “top CMT”. When the CMT 23 corresponds to the “top CMT”, the collecting section 17 sets (records) the address of the CMT 23 as “top CMT pointer” in the SMT 22 which corresponds to the calling source subroutine (step S119). Thereafter, processing proceeds to step S121.

On the other hand, when the CMT 23 does not correspond to the “top CMT”, the collecting section 17 sets (records) the address of the above CMT 23 as “next CMT pointer” in another CMT 23 which immediately precedes the above CMT 23 (step S120). Thereafter, processing proceeds to step S121.

In step S121, the collecting section 17 determines whether there is an SMT 22 which corresponds to the calling destination subroutine. That is, the collecting section 17 retrieves an SMT 22 wherein the address set as “branch destination address” (calling destination subroutine address) in the CMT 23 is recorded as “subroutine address” from the control table 18.

When no corresponding SMT 22 exists, the collecting section 17 shifts processing to step S123. On the other hand, when the corresponding SMT 22 has been found, the collecting section 17 sets (records) the address of the SMT 22 as the “calling destination SMT pointer” in the CMT 23 (step S119). Thereafter, processing proceeds to step S123.

In step S123, the collecting section 17 sets (records) the address of the CMT 23 as “present CMT pointer” in the SMT 22 which corresponds to the calling source subroutine.

Then, the collecting section 17 for example extracts the present time and stores it as the “final calling time” in the CMT 23 (step S124). The collecting section 17 terminates the interrupt and returns control to the CPU 2. Thereafter, the subroutine which was called by nesting is executed by the executor 19.

However, when it has been determined that the branch instruction is a return instruction and processing has reached step S125 of FIG. 7, the collecting section 17 determines whether the return instruction is a return instruction to another subroutine. Specifically, the collecting section 17 determines whether the branch destination address obtained from the analyzing section 16 represents the address of a subroutine.

When the branch destination address is not the address of a subroutine (i.e. when it is the address of a main routine), the collecting section 17 deems that the return instruction is not a return instruction to another subroutine and shifts processing to step S126. In contrast, when the branch destination address is the address of a subroutine, the collecting section 17 deems that the return instruction is a return instruction to another subroutine and shifts processing to step S130.

In step S126, the collecting section 17 increments the “times of calling” in the SMT 22 by “1 ”. Then, the collecting section 17 extracts the present time (step S127) and calculates the execution time of the subroutine based on the present time and the “final calling time” stored in the SMT 22 (step S128).

The collecting section 17 updates the “cumulative execution time” of the SMT 22 by adding the execution time, calculated in step S118, thereto (step S129). Then, the collecting section 17 terminates the interrupt processing and returns control to the CPU 2.

On the other hand, when the processing has reached step S130, the collecting section 17 increments the “times of calling” of the CMT 23 by “1”. Then, the collecting section 17 extracts the present time (step S131) and calculates the execution time of the subroutine based on the present time and the “final calling time” stored in the CMT 23 (step S132).

The collecting section 17 updates the “cumulative execution time” of the CMT 23 by adding the execution time, calculated in step S132, thereto (step S133). Then, the collecting section 17 terminates the interrupt processing and returns control to the CPU 2.

<Operation of the Embodiment>

According to the apparatus for collecting profiles of programs according to this embodiment, when the execution environment setting section 15 sets the CPU 2 to execute a branch instruction during execution of the application 9, an interrupt is generated and control passes from the CPU 2 to the analyzing section 16. The analyzing section 16 and the collecting section 17 create a control table 18 for each of the executors 19 of the subroutines. Profiles of the subroutines executed by the executors 19 are stored in the control tables 18.

The SMTs 22 in the control tables 18 store profiles comprising the times of calling of the subroutines called from the main routine, the cumulative execution time, and the final calling time. The CMTs 23 in the control tables 18 store profiles comprising the times of calling of other subroutines called from a subroutine, the cumulative execution time, and the final calling time. The CMTs 23 hold information (calling relationship information) representing the calling relationship between subroutines by storing the addresses of the calling source subroutine and the calling destination subroutine.

Since the processes (processed by executing analyzing program 10) of the analyzing section 16 and the collecting section 17 described above are carried out by an interrupt using the functions of the CPU 2, there is no need to alter the application 9. Therefore, this embodiment does not have the conventional drawbacks of overheads being increased by burying control codes in the program, and program malfunction caused by alteration of the programs.

When the application 9 has been executed, a plurality of control tables 18 are created for storing profiles and calling relationship information of the plurality of subroutines contained in the application 9. The operator of the computer 1 can display the contents of the control tables 18 on the display 7 and print them on a sheet of paper or the like by using a printer (not shown) by manipulating the input device 11. The contents of the control tables 18 which are displayed on the display 7 and printed on the sheet are used as documents in altering the application 9 and creating new application programs.

In this embodiment, the SMT 22 stores the profiles of subroutines which have been called from the main routine, and the CMT 23 stores the profiles of subroutines which have been called from other subroutines. The cumulative execution time for executing the application 9 of a given subroutine can be obtained by adding the numbers of calls and the cumulative execution times in the SMT 22 and the CMT 23.

In contrast, it is acceptable to store the “times of calling” and “cumulative execution time” in the SMT 22, and store the “times of calling” and “cumulative execution time”, from among those which are stored in the SMT 22, of cases when there has been a call from another subroutine in the CMT 23.

It then becomes possible to obtain the “times of calling” and “cumulative execution time” when there is calling from the main routine by subtracting the “times of calling” and “cumulative execution time” stored in the CMT 23 from the “times of calling” and “cumulative execution time” stored in the SMT 22.

[Second Embodiment]

Subsequently, the apparatus for collecting profiles of programs according to a second embodiment of this invention will be explained. In the second embodiment, in addition to the constitution of the first embodiment, overheads are stored in the control table 18 as part of the profile of the subroutine.

In the second embodiment, the collecting section 17 stores the number (times) of interrupts which were generated by executing a branch instruction during execution of the application 9 in the SMTs 22 and the CMTs 23 in compliance with the branch source address (branch destination address) for each subroutine.

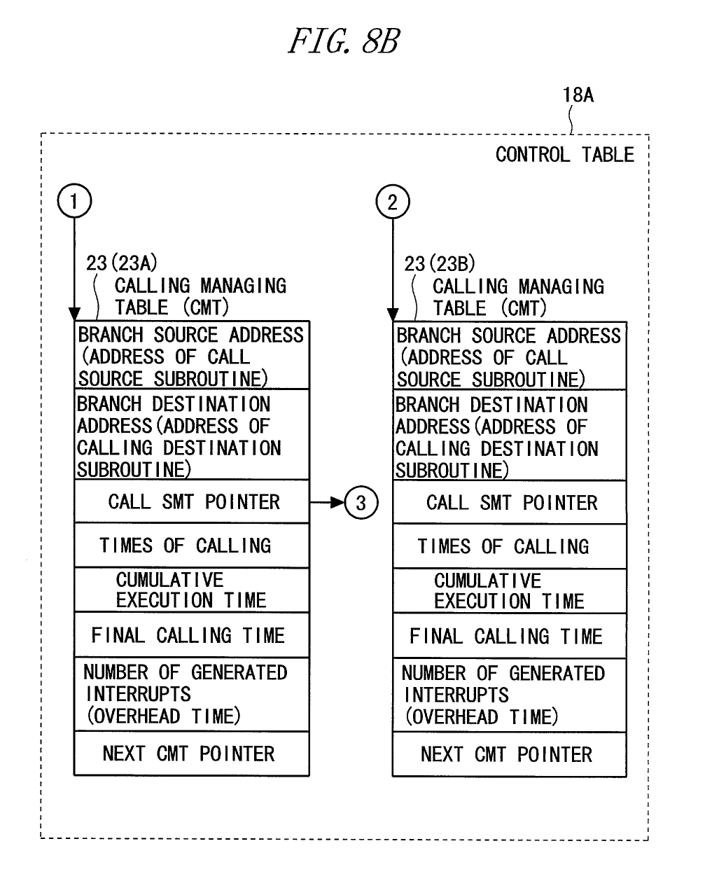

The collecting section 17 divides the total number of generated calling instructions, return instructions, and jump instructions for each subroutine into calls to that subroutine from the main routine and calls from other subroutines, and stores these in the corresponding SMT 22 and CMT 23. The collecting section 17 also calculates the average overhead time. FIGS. 8A and 8B show one example of the constitution of the control table 18A in the second embodiment.

During or after the execution of the application 9, the collecting section 17 multiplies the number of generated interrupts stored in the SMTs 22 and the CMTs 23 by the calculated average overhead time, and stores the result as overhead time during the execution of each subroutine in the SMTs 22 and the CMTs 23.

According to the second embodiment, overhead is stored in the control tables 18 are profiles of the subroutines. Therefore, more detailed profiles can be obtained than in the first embodiment, increasing the precision of the profiles.

What is claimed is:

1. An apparatus for collecting a profile of a subroutine in a program, the apparatus collecting the profile of said subroutine by using an interrupt generated when a branch instruction is executed during execution of said program.

2. An apparatus according to claim 1, which collects said profile for each executor of a subroutine.

3. An apparatus according to claim 2, which individually collects profiles of a plurality of subroutines executed by a specific executor.

4. An apparatus according to claim 3, which individually collects a first profile of a subroutine called by a main routine, and a second profile of this subroutine called by another subroutine.

5. An apparatus according to claim 4, which stores said second profile and calling relationship information relating to said second profile, said calling relationship information indicating a relationship between said other subroutine and said subroutine.

6. An apparatus according to claim 1, wherein said profile of said subroutine comprising at least one from a cumulative value of execution time, times of calling, time of final calling, and an overhead.

7. An apparatus according to claim 1 comprising:
a storage unit storing a profile of a subroutine;
an analyzing section judging whether or not an executed branch instruction is an instruction relating to the execution of said subroutine when said interrupt is generated; and
a collecting section, when said analyzing section identifies that said executed branch instruction is the instruction relating to the execution of said subroutine, for obtaining a profile of said subroutine and stores said obtained profile in said storage unit.

8. An apparatus according to claim 7, wherein a plurality of storage unit respectively corresponding to a plurality of executors of said subroutine are prepared; and
said collecting section specifies said executor of said subroutine and stores said profile of said subroutine corresponding to said specified executor in said storage unit.

9. An apparatus according to claim 8, wherein said collecting section individually stores profiles of a plurality of subroutines corresponding to a specified executor in said storage unit.

10. An apparatus according to claim 9, wherein said collecting section individually stores a first profile of a subroutine called by a main routine, and a second profile of the subroutine called by another subroutine, in said storage unit.

11. An apparatus according to claim 10, wherein said collecting section stores said second profile and calling relationship information relating to said second profile, said calling relationship information indicating a relationship between said other subroutine and said called subroutine, in said storage unit.

12. An apparatus according to claim 1, further comprising:
a storage unit storing a profile;
an analyzing section, when said interrupt generates, obtaining a branch source address and a branch destination address from a source of said interrupt, and identifying a type of said brunch instruction by obtaining a instruction code from said brunch source address and decoding said instruction code; and
a collecting section obtaining said brunch source address, said brunch destination address, and a identified result from said analyzing section when the identified instruction is a calling instruction or a return instruction of said subroutine; when said identified result is said calling instruction, storing said brunch destination address as a subroutine address corresponding to said calling instruction and a calling time of said subroutine corresponding to said calling instruction in said storage unit; and when said identified result is said return instruction, obtaining a return time of said subroutine corresponding to said return instruction, calculating a execution time of said subroutine based on said obtained return time and said calling time, and storing a cumulative value of said execution time as said profile in correspondence with said branch destination address in said storage unit.

13. An apparatus according to claim 12, wherein said collecting section stores times of calling of said subroutine corresponding to said brunch destination address as said profile in said storage unit.

14. An apparatus according to claim 12, wherein said collecting section obtains an overhead of said subroutine as said profile and stores said overhead in said storage unit.

15. An apparatus according to claim 13, wherein said collecting section, when said identified result is said calling instruction, stores an identifier of an executor of said subroutine corresponding to said calling instruction and said brunch destination address in said storage unit.

16. An apparatus according to claim 13, wherein said collecting section, when said identified result is said calling instruction and said brunch source address and said branch destination address are addresses of said subroutines, stores said branch source address and branch destination address as calling relationship information indicating a calling source subroutine and a calling destination subroutine in said storage unit, and stores at least one of the cumulative execution time and the times of calling in said calling destination subroutine in the call source subroutine, as said profile corresponding to said calling relationship information, in said storage unit.

17. An apparatus according to claim 7, further comprising a setting section setting an execution environment of a source of said interrupt so as to generate said interrupt when said branch instruction is executed during the execution of said program.

18. A computer readable medium stores a program in order that a computer executes a process for collecting a profile of a subroutine included another program as an analizing target, said program comprising steps of:
identifying, when an interrupt is generated by an execution of a brunch instruction during the execution said other program, whether or not said executed brunch instruction is an instruction relating to the execution of said subroutine;
obtaining, when said brunch instruction is the instruction relating to the execution of said subroutine, said profile of said subroutine; and
storing said profile in a storage unit.

19. A computer readable medium according to claim 19, wherein said program further comprises steps of:
specifying an executor of said subroutine; and
storing said profile in a storage unit corresponding to said specified executor within a plurality of storage unit provided with each executor.

20. A computer readable medium according to claim 19, wherein said program further comprises step of storing, when a specified executor executes a plurality of subroutines, profiles of said plurality of subroutines in said storage unit corresponding to said specified executor.

21. A computer readable medium according to claim 20, wherein said program further comprises step of storing a first profile of said subroutine called by a main routine and a second profile of said subroutine called by another subroutine in said corresponding storage unit, regarding to each of said subroutines.

22. A computer readable medium according to claim 21, wherein said program further comprises step of storing said second profile and calling relationship information relating to said second profile, said calling relationship information indicating a relationship between said other subroutine and said subroutine.

23. A computer readable medium according to claim 18, wherein said program further comprises steps of:
obtaining a branch source address and a branch destination address from a source of said interrupt when said interrupt generates;
identifying a type of said brunch instruction by obtaining a instruction code from said brunch source address and decoding said instruction code;
storing said brunch destination address as a subroutine address corresponding to said calling instruction and a calling time of said subroutine corresponding to said calling instruction in said storage unit when said identified result is said calling instruction; and,
when said identified result is said return instruction, obtaining a return time of said subroutine corresponding to said return instruction, calculating a execution time of said subroutine based on said obtained return time and said calling time, and storing a cumulative value of said execution time as said profile in correspondence with said branch destination address in said storage unit.

24. A computer readable medium according to claim 23, wherein said program further comprises step of storing times of calling of said subroutine corresponding to said brunch destination address as said profile in said storage unit.

25. A computer readable medium according to claim 23, wherein said program further comprises step of storing an overhead of said subroutine as said profile in said storage unit.

26. A computer readable medium according to claim 23, wherein said program further comprises step of storing, when said identified result is said calling instruction, an identifier of an executor of said subroutine corresponding to said calling instruction and said brunch destination address in said storage unit.

27. A computer readable medium according to claim 23, wherein said program further comprises steps of, when said identified result is said calling instruction and said brunch source address and said branch destination address are addresses of said subroutines, storing said branch source address and branch destination address as calling relationship information indicating a calling source subroutine, and a calling destination subroutine in said storage unit; and storing at least one of the cumulative execution time and the times of calling in said calling destination subroutine in the call source subroutine, as said profile corresponding to said calling relationship information, in said storage unit.

28. A computer readable medium according to claim 18, wherein said program further comprises step of setting an execution environment of a source of said interrupt so as to generate said interrupt when said branch instruction is executed during the execution of said program.

29. A method for collecting a profile of a subroutine in a program, comprising steps of:
identifying, when an interrupt is generated by an execution of a brunch instruction during the execution the program, whether or not the executed brunch instruction is an instruction relating to the execution of the subroutine;
obtaining, when the brunch instruction is the instruction relating to the execution of the subroutine, the profile of the subroutine; and
storing the profile in a storage unit.

30. A method according to claim 29, further comprising steps of:
specifying an executor of the subroutine; and
storing the profile in a storage unit corresponding to the specified executor within a plurality of storage unit provided with each executor.

31. A method according to claim 30, further comprising step of storing, when a specified executor executes a plurality of subroutines, profiles of the plurality of subroutines in the storage unit corresponding to the specified executor.

32. A method according to claim 31, further comprising step of storing a first profile of the subroutine called out by a main routine and a second profile of the subroutine called out by another subroutine in the corresponding storage unit, regarding to each of the subroutines.

33. A method according to claim 32, further comprising step of storing the second profile and calling relationship information relating to the second profile, the calling relationship information indicating a relationship between the other subroutine and the subroutine.

34. A method according to claim 29, further comprising steps of:
obtaining a branch source address and a branch destination address from a source of the interrupt when the interrupt generates;
identifying a type of the brunch instruction by obtaining a instruction code from the brunch source address and decoding the instruction code;
storing the brunch destination address as a subroutine address corresponding to the calling instruction and a calling time of the subroutine corresponding to the calling instruction in the storage unit when the identified result is the calling instruction; and
when the identified result is the return instruction, obtaining a return time of the subroutine corresponding to the return instruction, calculating a execution time of the subroutine based on the obtained return time and the calling time, and storing a cumulative value of the execution time as the profile in correspondence with the branch destination address in the storage unit.

35. A method according to claim 34, further comprising step of storing times of calling of the subroutine corresponding to the brunch destination address as the profile in said storage unit.

36. A method according to claim 34, further comprising step of storing an overhead of the subroutine as the profile in the storage unit.

37. A method according to claim 34, further comprising step of storing, when the identified result is the calling instruction, an identifier of an executor of the subroutine corresponding to the calling instruction and the brunch destination address in the storage unit.

38. A method according to claim 34, further comprising steps of, when the identified result is the calling instruction and the brunch source address and the branch destination address are addresses of the subroutines, storing the branch source address and the branch destination address as calling relationship information indicating a calling source subroutine, and a calling destination subroutine in said storage unit; and storing at least one of the cumulative execution time and the times of calling in the calling destination subroutine in the call source subroutine, as the profile corresponding to the calling relationship information, in the storage unit.

39. A method according to claim 29, further comprising step of setting an execution environment of a source of the interrupt so as to generate the interrupt when the branch instruction is executed during the execution of the program.
